(19) United States
(12) Patent Application Publication
(10) Pub. No.: US 2025/0369525 A1
(43) Pub. Date: Dec. 4, 2025

(54) PNEUMATIC VALVE WITH AN SMA ACTUATOR

(71) Applicant: Conti Temic microelectronic GmbH, Ingolstadt (DE)

(72) Inventors: Michael Beuschel, Stammham (DE); Johann Steinberger, Brunnen (DE); Stefan Bauer, Engelbrechtsmünster (DE)

(73) Assignee: Conti Temic microelectronic GmbH, Ingolstadt (DE)

(21) Appl. No.: 19/219,077

(22) Filed: May 27, 2025

(30) Foreign Application Priority Data
May 28, 2024 (DE) 10 2024 204 954.9

(51) Int. Cl. F16K 11/22; B60N 2/90; F16K 11/24; F16K 31/00

(52) U.S. Cl. CPC F16K 11/22; B60N 2/914; F16K 11/24; F16K 31/002

(57) ABSTRACT

A pneumatic valve includes a fluid supply port, a fluid outlet port, and a fluid drainage opening. A valve chamber includes a fluid supply opening connected to the fluid supply port, a fluid outlet opening connected to the fluid outlet port, a trigger opening connected to an actuator chamber having the fluid drainage opening. An actuator disposed in the actuator chamber is formed with an SMA wire includes an actuating element and a resetting element. A sealing element is arranged on the actuating element and is pressed against the trigger opening by the resetting element in a non-actuated state and opens up the trigger opening in an actuated state. A membrane divides the valve chamber into two a first region connected to the trigger opening and a second region connected to the fluid supply opening.

### CROSS-REFERENCE TO RELATED APPLICATIONS

This application claims priority to German patent application No. 10 2024 204 954.9, filed May 28, 2024, which is incorporated by reference in its entirety.

### TECHNICAL FIELD

The technical field relates generally to a pneumatic valve, and specifically to a pneumatic valve to control a fluid flow for filling elastic cushions in vehicles for forming seat contours.

### BACKGROUND

Such a pneumatic valve is known from DE 10 2019 208 051 B4. There, a membrane closes a fluid supply opening of a valve chamber, while the fluid outlet opening is continuously open. A plunger which is actuated by a leaf spring and is connected to the membrane protrudes through the trigger opening in order, in the unactuated state, to press the membrane against the fluid supply opening. The trigger opening is closed by the membrane in the actuated state of the actuator, but the trigger opening is open in the unactuated state, and therefore fluid from a consumer connected to the fluid outlet port, for example, a bladder to be filled with fluid—for example, air—is discharged via the fluid outlet port, holes in the membrane and the trigger opening into the actuator chamber and from there into the environment via the fluid outlet opening. This is therefore a 3/2 NC valve.

In the case of a similarly designed valve according to DE 10 2018 216 874 A1, the air also has to flow serially through two nozzle openings during the filling operation, and therefore, because of the additional flow resistance, the volumetric flow rate is reduced compared to a single nozzle passage.

Such pneumatic valves are used to control a fluid flow for filling elastic cushions in vehicles for forming seat contours. For this purpose, the elastic cushions are generally filled with air as a fluid.

As an actuator for such valves, shape memory wire (SMA=shape memory alloy) is increasingly being used, which shortens in length in the event of current flow and the resulting heating.

For the high volumetric flow rate required for some functions, such as cushion adjustment, depending on driving dynamic states, large valve cross sections and thus high actuating and sealing forces are required for them. An SMA actuator that can provide them requires appropriately large dimensioning, as a result of which costs and space requirements increase.

For valves with high volumetric flow rates, the following options are known according to the prior art:

By connection of a plurality of individual valves in parallel, the volumetric flow rate can be scaled. However, costs and installation space are therefore also correspondingly increased.

By way of example for a multiplicity of industrial valves, DE 43 31 568 C2 and DE 43 31 515 A1 respectively disclose servo and pilot solenoid valves which are actuated with an auxiliary flow and control a greater pressure or volumetric flow rate with little actuating effort.

U.S. Pat. No. 9,080,682 B2 discloses a valve, in which SMA wires, via a deflection, activate two pilot control valves for actuating a main valve. The deflection is guided by a sealing element, which reduces the available actuating force of the SMA wire.

EP 3 078 890 B1 also discloses a pilot valve actuated by an SMA wire. The SMA wire is located in the pressure range of the working port of the main valve; therefore, the associated electrical contacts have to be airtight, which increases the outlay and thus the costs.

A pneumatic valve of the type in question is also described in DE 10 2023 208 359.0, which has not been published previously. There, the membrane has at least one passage opening through which fluid can flow from the first region into the second region, the passage opening having a smaller cross section than the trigger opening.

It is therefore desirable to present a compact pneumatic valve with a large nozzle cross section. An SMA actuator for actuation is intended to be loaded as little as possible in respect of force and travel. It is intended, in addition, for no outlay on sealing to be necessary for the ports of the SMA actuator.

### SUMMARY

In a pneumatic valve as described herein, a sealing element is arranged on an actuating element, the sealing element being pressed against a trigger opening by a resetting element in a non-actuated state of an actuator and opening up the trigger opening in the actuated state of the actuator. In addition, the membrane is clamped with its edge between a cup-shaped element forming the valve chamber and a cover element inserted therein, wherein, in the region of the clamping, at least one passage opening is formed between the first region and the second region, through which fluid can flow from the first region into the second region.

In the unactuated state, the valve chamber of the pneumatic valve is thus connected to the air supply via the fluid supply port, with the same pressure being set both in the first and in the second region of the valve chamber, and therefore the membrane not being loaded, because of the passage opening in the membrane. In the actuated state, the actuator opens the trigger opening, and therefore air can escape from the first region into the actuator chamber and from there into the environment. Owing to the higher pressure in the second region, the plunger, which is connected to the membrane, is lifted off the outlet opening counter to the spring force because of the effective area of the membrane, and therefore the air can flow through the valve into a connected consumer—for example, a cushion. Thus, only a small force is necessary for actuating the SMA actuator, since the pressure of the inflowing air is used to open the valve. Since the passage opening has a smaller cross section than the trigger opening, the compressed air flowing into the second region cannot pass into the first region quickly enough, and therefore a greater pressure prevails in the second region as long as the trigger opening is opened up.

The actuating element can be designed as a leaf spring, which acts simultaneously as a resetting element. A non-movable end of the actuating element (bending section) can be connected to the printed circuit board and the movable end (actuating section) can be connected to the SMA wire.

It is also possible to realize the resetting element with a spiral spring, as is shown, for example, in DE 10 2018 216 874 A1.

In a first embodiment variant, in the pneumatic valve, the membrane has at least one groove forming the passage opening and surrounding the edge thereof in the region of the cup-shaped element and the cover element.

At its edge, the membrane can have a surrounding bead. The groove or depression is radially positioned along the outside of the edge or optionally the bead. The groove lies in each case against the cover element and the cup-shaped element and allows pressure between the first and the second regions to be equalized.

Such a depression can be introduced, for example, as a rectangular, triangular groove (“V groove”) or semicircular groove in an injection mold for the membrane in a simple manner by means of corresponding contours.

A second embodiment variant provides that the membrane has at least one bead producing the passage opening in the clamped state and surrounding the edge thereof in the region of the cup-shaped element and the cover element.

Instead of the radially extending depression, an elevation is therefore formed here, which, in the clamped state of the membrane, also permits in the latter a passage opening between the first and the second region and thus pressure compensation.

In a third embodiment, the cup-shaped element and the cover element in their regions surrounding the edge of the membrane have at least one groove forming the passage opening.

The passage opening here therefore consists of a depression (flute) on the cup-shaped element and a further depression on the cover element. These depressions can be introduced, for example, as a rectangular, triangular groove (“V groove”) or semicircular groove in injection molds in a simple manner by means of corresponding contours or else in a simple way by means of subtractive manufacturing processes (e.g. milling).

In the region of the depressions, the elastic membrane can also partially penetrate said depressions and thus reduce the free cross section along the depression. With this effect, a smallest possible cross section of the depressions can be produced without having to select an unnecessarily small size for the depressions.

The depression in the cup-shaped element and the depression in the cover element can also be offset along the circumference of the membrane (e.g. offset by 90° or) 180°. Both depressions continue to be fluidically connected to each other via a circumferential slot between the cover element, cup-shaped element and membrane. Such an offset can cause an additional flow resistance and thus reduce the working air required. In this way, the acoustic emission from the flowing working air can also be minimized. Last but not least, this simplifies the installation of the valve, since there is no need to ensure that the two depressions are aligned.

In a fourth embodiment, the cup-shaped element and the cover element in their regions surrounding the edge of the membrane have at least one bead producing the passage opening in the membrane in the clamped state.

This bead or this elevation is pressed in each case into the originally smooth edge, optionally with a formed and surrounding bead of the membrane. As a result of the elasticity of the membrane, the latter is compressed there to such an extent that a channel forms next to the elevation. Such a channel is formed in particular when there is a concave (“sharp”) edge at the transition to the elevation, against which edge the elastic membrane, even with slight compression, cannot adhere with a form fit.

Such an elevation can be introduced, for example, as a rectangular, triangular or semicircular web in an injection mold for the cover element and the cup-shaped element in a simple manner by means of corresponding contours.

In a fifth embodiment variant, channels forming the passage opening are formed in the cup-shaped element and the cover element.

The channels can be bores or cutouts provided during the production of the cover element and the cup-shaped element.

The contours mentioned of the above embodiments can also be used in different combinations, and therefore, for example, a channel in a partial region of the cup-shaped element is combined with a groove in the membrane edge. In the same way, a groove in the one part can be combined with an elevation in the other region.

### BRIEF DESCRIPTION OF THE DRAWINGS

The disclosure will be explained in more detail below on the basis of exemplary embodiments with the aid of figures, in which:

FIG. 1 shows a cross-sectional illustration of a first embodiment variant of a pneumatic valve,

FIG. 2 shows the valve chamber of the first embodiment variant of FIG. 1 in a detailed view,

FIG. 3 shows the valve chamber of a second embodiment variant in a detailed view,

FIG. 4 shows a detailed illustration of the passage opening in the valve chamber wall from the side,

FIG. 5 shows the detailed illustration of the passage opening in the valve chamber wall in a longitudinal section,

FIG. 6 shows a detailed illustration of the passage opening in the membrane because of a bead in the valve chamber wall from the side,

FIG. 7 shows a detailed illustration of the passage opening in the membrane because of a bead in the valve chamber wall from above,

FIG. 8 shows a detailed illustration of the passage opening in the membrane because of a groove in the membrane from the side,

FIG. 9 shows a detailed illustration of the passage opening in the membrane because of a groove in the membrane from above,

FIG. 10 shows a detailed illustration of the passage opening in the membrane because of a bead on the membrane from the side,

FIG. 11 shows a detailed illustration of the passage opening in the membrane because of a bead on the membrane from above,

FIG. 12 shows a detailed illustration of the bead at the membrane edge in cross section,

FIG. 13 shows the bead on the membrane of FIG. 12 in the pressed-in state with formation of the passage opening,

FIG. 14 shows a 3/3-NC valve with an embodiment of the pneumatic valve according to the invention in a first state, and

FIG. 15 shows the 3/3-NC valve in a second state,

FIG. 16 shows the 3/3-NC valve in a third state,

FIG. 17 shows a 3/3-NO valve in a first state.

### DETAILED DESCRIPTION

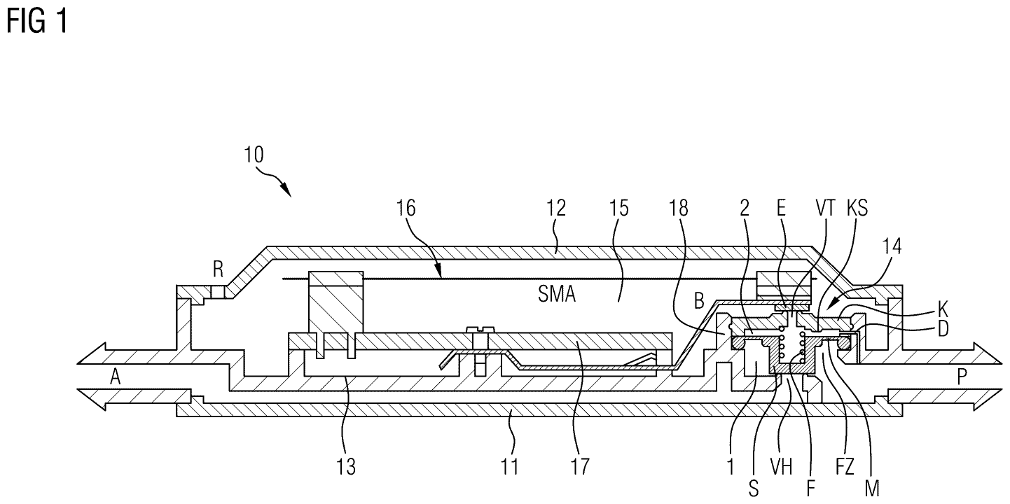

FIG. 1 shows a cross-sectional illustration of a first exemplary embodiment of a pneumatic valve, which is formed with a housing 10, which has a first housing part 11, which is designed as a base plate in the illustrated exemplary embodiment. The housing 10 also has a second housing part 12, which is designed as a cover, and, finally, a third cup-shaped housing part 13, which is designed as an insert part between the first and the second housing parts 11, 12 and on which a fluid supply port P and a fluid outlet port A are integrally formed. In the second housing part 12, a fluid drainage opening R is formed, which connects an actuator chamber 15, which is formed between the second housing part 12 and the third housing part 13 and in which an actuator 16 is arranged, to the environment such that openings for electrical connections of the actuator 16 do not have to be sealed.

A valve chamber 14 is formed on the third housing part 13 by the latter having a pot-shaped or cup-shaped molding 18 into which a cover element K is inserted as a cover of the valve chamber 14. The valve chamber 14 has a fluid supply opening FZ, a fluid outlet opening VH acting as the main valve, and a trigger opening VT. In the illustrated exemplary embodiment, the fluid supply opening FZ and the fluid outlet opening VH are formed in the third housing part 13 and the trigger opening VT is formed in the cover element K closing the valve chamber 2.

It is thus possible for compressed air to be guided via the fluid supply opening FZ, for example, from a compressor, into the housing 10, wherein the compressed air can pass via the fluid supply opening FZ into the valve chamber 14 and from there via the fluid outlet opening VH and the fluid outlet port A into a consumer, for example an air cushion, which is connectable thereto.

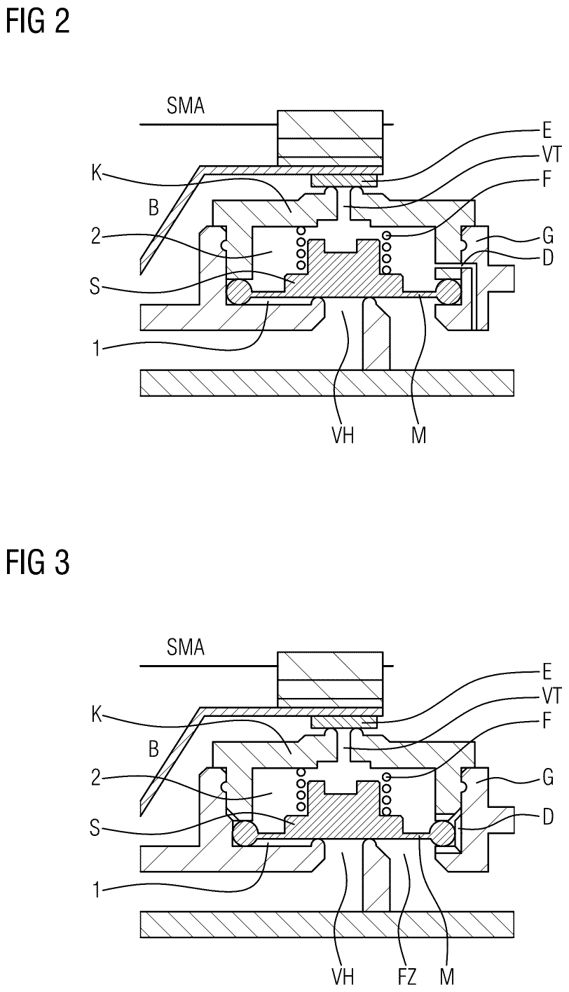

As can be seen in detail in FIG. 2, an elastic membrane M divides the valve chamber 14 into a lower, first region 1, in the illustration of the figures, and an upper, second region 2. The valve chamber 14 is substantially formed by a cup-shaped element G, which is formed by the cup-shaped molding 18 (FIG. 1), and the cover element K. The first region 1 is connected to the fluid supply opening FZ and thus to the fluid supply port P. The second region 2 is closed by a cover element K in relation to the actuator chamber 15 and thus in relation to the environment.

The membrane M is connected to a plunger S. The plunger S has a sealing surface on its underside in order to close the nozzle seat of the fluid outlet opening VH in its lower end position. The plunger S can be manufactured from an elastic material integrally with the membrane M or else can be a component assembled with the plunger S. An elastic element F, e.g., a spring, which is attached between the cover element K and the plunger S, generates a resetting force for closing the fluid outlet opening VH by means of the plunger S. The elastic element F can optionally also be formed with the membrane M, which, by means of its inherent stress, pulls the plunger S into the lower end position closing the fluid outlet opening VH.

An associated SMA actuator 16 consists of a leaf spring B and an SMA wire SMA, wherein the leaf spring B has a bending section and an actuating section, which are respectively arranged on opposite sides of an electrical printed circuit board 17 and in the ambient pressure in the actuator chamber 15. The cover element K has the trigger opening VT, which acts as a trigger valve. A sealing element E, which can seal the trigger opening VT, is fastened to the underside of an actuating section of the leaf spring B.

In the embodiment variant of a pneumatic valve of FIGS. 1 and 2, a channel is formed as a passage opening D both in the cup-shaped element G and in the cover element K, said channel allowing a limited air flow (working air) from the first region 1 into the second region 2 of the valve chamber 14. The channel can be realized both by means of bores and by means of recesses, which can already be provided as corresponding pins, for example, in the molds for producing the cup-shaped element G and the cover element K.

In a “holding” state (i.e. the SMA actuator of the valve element V1 in FIG. 14, right, is not activated), the trigger opening VT is closed. The lower region 1 and the upper region 2 of the valve chamber 14 are connected to each other via the passage opening D, and therefore the pressure is equalized. Thus, even at a high or variable pressure of the pressure supply P, no pneumatic force acts on the membrane M. The spring element F pushes the plunger S, which is connected to the membrane M, against the nozzle seat of the fluid outlet opening VH and seals the latter. The force of the spring element F is configured in such a way that, in the most unfavorable case (e.g. max. consumer pressure and min. supply pressure), it can apply compressive and sealing forces.

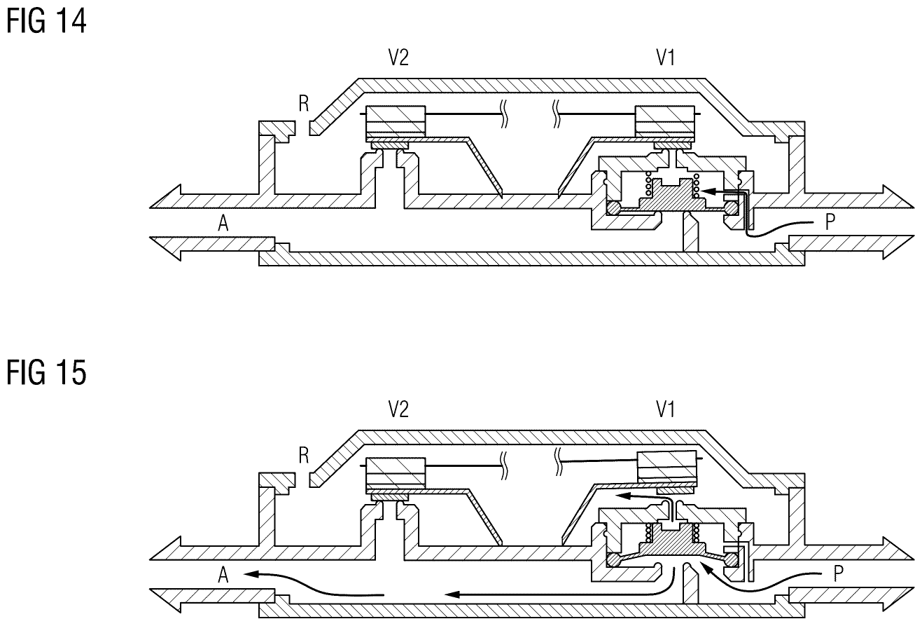

At the beginning of the “filling” state (i.e. the SMA actuator of the valve V1 is activated, see FIG. 15, right), the trigger opening VT is open. Preferably, although the cross section of the trigger opening VT is as small as possible, it is nevertheless substantially larger than the cross section of the passage opening D. As a result, the pressure in the upper region 2 of the valve chamber 14 drops and approaches the ambient pressure. The pressure difference in relation to the supply pressure in the lower region 1 of the valve chamber 14 now causes an upwardly directed force on the membrane M, as a result of which the plunger S opens the fluid outlet opening VH.

Owing to the small cross section of the trigger opening VT compared to the cross section of the fluid outlet opening VH, the associated SMA actuator requires only a small travel and a limited force for actuation. This is of benefit for the service life (in particular the number of actuation cycles) of the SMA wire SMA.

Preferably, the effective area of the membrane M is substantially larger than the cross section of the fluid outlet opening VH. Thus, even in the event of the consumer being unpressurized, the fluid outlet opening VH can be opened counter to a high preliminary pressure and counter to the force of the spring element F. The pressure supply at P provides the additional energy for the opening (“servo valve”). The preliminary pressure can vary over a wide range; it merely has to be at least of a magnitude such that the compressive force on the membrane M is greater than the resetting force of the spring F.

Advantageously, the entire air supply region has a larger cross section than the fluid outlet opening VH, and therefore the pressure in the second region 2 of the valve chamber 14 substantially corresponds to the pressure of the pressure supply even when the fluid outlet opening VH is open.

During the “filling” state, a limited working air flow flows through the passage opening D and the open trigger opening VT from the pressure supply into the environment.

At the end of the filling operation (i.e. the SMA actuator is deactivated), the trigger opening VT is closed again. Via the passage opening D, the pressure between the lower region 1 and the upper region 2 of the valve chamber 14 is then equalized again. The force of the spring element F consequently also causes the fluid outlet opening VH to be closed again. When the valve is not actuated, the arrangement also does not consume any working air.

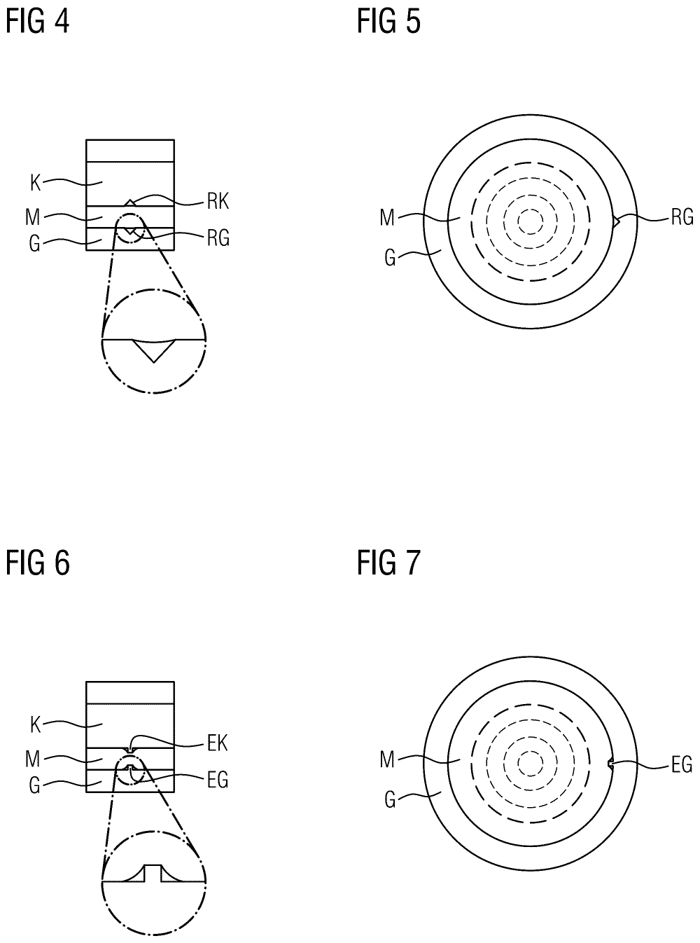

A further embodiment variant of a pneumatic valve is shown in FIGS. 3 to 5. Here, the passage opening D is formed as depressions or grooves RG, RK in the cup-shaped element G or the cover element K. The grooves RG, RK are oriented with respect to each other in such a way that they form a continuous passage opening.

The depressions RG, RK can be introduced, for example, as a rectangular, triangular groove (“V groove”) or semicircular groove in injection molds in a simple manner by means of corresponding contours or else in a simple way by means of subtractive manufacturing processes (e.g. milling).

In the region of the depressions RG, RK, the elastic membrane M can also partially penetrate said depressions and thus reduce the free cross section along the depression. With this effect, a smallest possible cross section of the depressions can be produced without having to select an unnecessarily small size for the depressions.

The depression RG in the cup-shaped element G and the depression RK in the cover element K can also be offset along the circumference of the membrane M (e.g. offset by 90° or) 180°. Both depressions continue to be fluidically connected to each other via a circumferential slot, visible in FIG. 3, between the cover element K, the cup-shaped element G and the membrane M. Such an offset can cause an additional flow resistance and thus reduce the working air required. In this way, the acoustic emission from the flowing working air can also be minimized. Last but not least, this simplifies the installation of the valve, since there is no need to ensure that the two depressions are aligned.

Another embodiment variant of a pneumatic valve is shown in FIGS. 6 and 7. Here, the cup-shaped element G and the cover element K each have an elevation or bead EG, EK, which press into the edge of the membrane M or a bead formed thereon and, in the assembled state, form the passage opening D. This can be seen particularly readily in the detailed illustration of FIG. 6.

As a result of the elasticity of the membrane M, the latter in the installed state is compressed to such an extent that, in addition to the elevation, a channel is formed (see FIG. 6 below, detailed illustration). Such a channel is formed in particular when there is a concave (“sharp”) edge at the transition to the elevation, against which edge the elastic membrane M, even with slight compression, cannot adhere with a form fit.

Such an elevation EG can be introduced, for example, as a rectangular, triangular or semicircular web in an injection mold for the cup-shaped element G (or the entire valve housing) and the cover element K in a simple manner by means of corresponding contours.

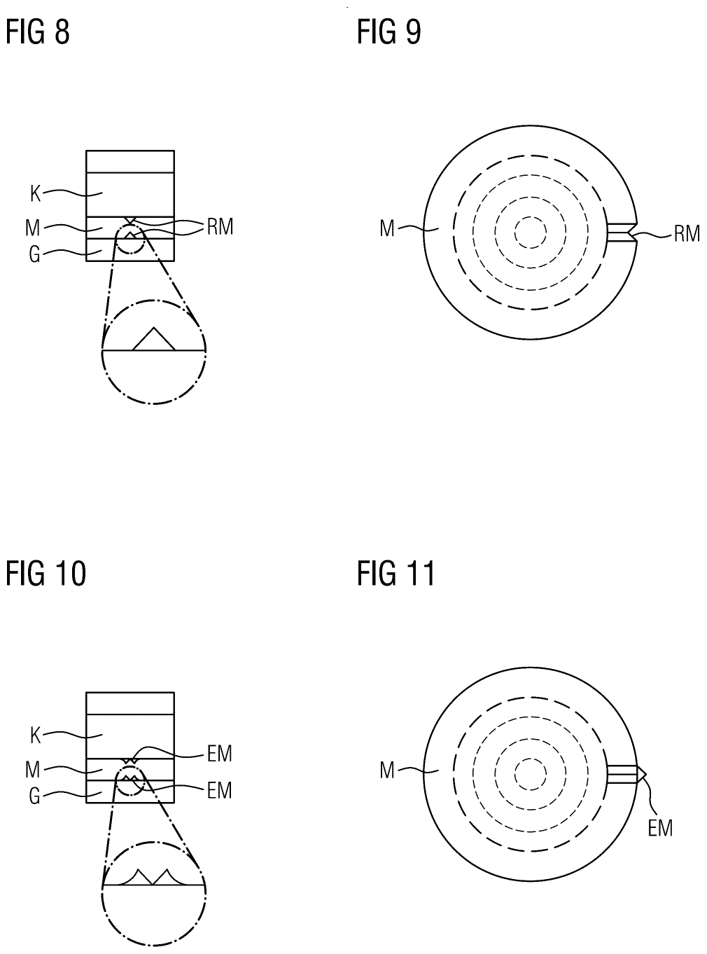

Yet another embodiment variant of a pneumatic valve is shown in FIGS. 8 and 9. Here, a depression or groove RM is provided at the edge of the membrane M or a bead formed thereon, which can already be formed during the production of the membrane M, or subsequently, by removal of material. This depression RM forms the passage opening D.

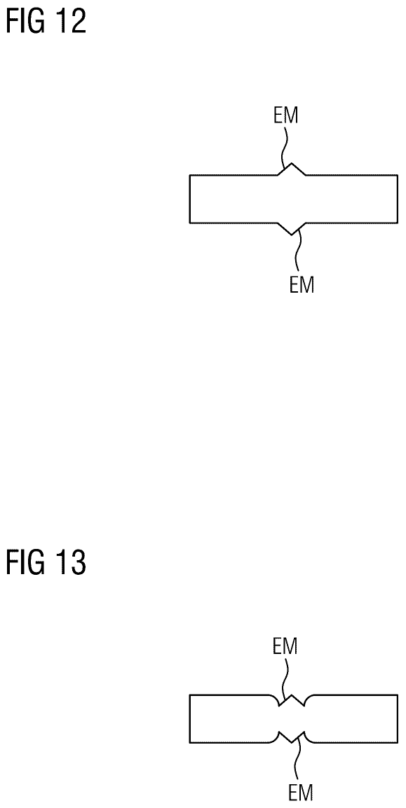

In the further embodiment variant of FIGS. 10 and 11, an elevation or bead EM is integrally formed at the edge of the membrane M or at a bead formed thereon, which elevation or bead, in the assembled state, is pressed into the membrane M and forms the passage opening D at its edges. This is illustrated in detail in FIGS. 12 and 13.

Such a channel is produced in particular if there is a concave edge at the transition to the elevation, which edge, even at slight compression, cannot adhere with a form fit against the smooth wall of the housing or cap.

Such an elevation EM can be introduced, for example, as a rectangular, triangular or semicircular web in an injection mold for the membrane M in a simple manner by means of corresponding contours.

As is illustrated in FIG. 16, the described servo valve, denoted by V1, can be combined in a simple manner with another valve V2 for venting a consumer connected to the fluid outlet port A. The depicted behavior of the valve arrangement thus corresponds to a 3/3 NC valve (normally closed).

In the “venting” state, the further valve V2 is actuated via the associated SMA actuator with an SMA wire and a leaf spring. A sealing element also fastened to the leaf spring then opens the associated nozzle seat (left). Thus, air can flow from the fluid outlet port A through the fluid drainage opening R into the environment.

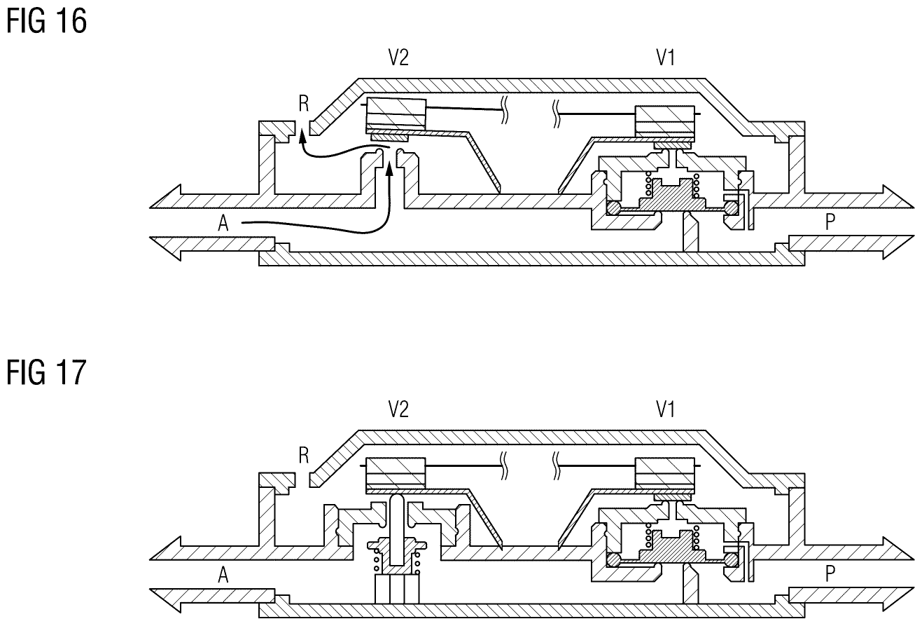

Likewise, the proposed servo valve can be combined with a pot valve V2, as is illustrated in FIG. 17. The additional cup valve V2, also with an SMA actuator according to the prior art, connects the fluid outlet port A to the fluid drainage opening R and thus to the environment in the inoperative state (not activated). When the SMA actuator is activated, a plunger with its upper sealing element closes the nozzle seat of the venting valve. The depicted behavior of the valve arrangement thus corresponds to a 3/3 NO valve (normally open).

In the described pneumatic valve, the passage opening can be realized cost-effectively via a depression or an elevation in the cover element and the cup-shaped element in the housing of the valve or in the membrane. The elasticity of the membrane enables the effective cross section of the respectively resulting channel as a through opening to be smaller than the geometry being manufactured. This reduces the accuracy requirement on the manufacturing process.

A single SMA actuator subjected to a low load can, by means of the servo function, actuate a large valve cross section for the filling. This increases the service life of the actuator. In addition, there is no need for valves which are connected in parallel, as a result of which installation space and costs can be reduced.

In the inoperative position, the servo valve does not consume any working air.

The servo control functions in a wide pressure range of the preliminary pressure.

The servo valve can be easily extended with another SMA actuator to form a 3/3 NC and NO valve.

The SMA actuator and the associated printed circuit board with electronics are not located in the pressure range and therefore also do not need to be sealed.

1. A pneumatic valve comprising:
a housing defining a fluid supply port, a fluid outlet port, and a fluid drainage opening;
a valve chamber having a fluid supply opening connected to the fluid supply port, a fluid outlet opening connected to the fluid outlet port, and a trigger opening connected to an actuator chamber which is connected to the fluid drainage opening;
an actuator formed with an SMA wire, an actuating element, a resetting element, and a printed circuit board, the actuator disposed in the actuator chamber, wherein a sealing element is arranged on the actuating element, the sealing element pressed against the trigger opening by the resetting element in the non-actuated state of the actuator and opening up the trigger opening in the actuated state of the actuator;
a membrane dividing the valve chamber into a first region connected to the trigger opening and a second region connected to the fluid supply opening;
wherein the membrane is connected to a plunger which, because of a spring force in the unactuated state of the actuator, is pressed against the fluid drainage opening to close the fluid drainage opening and, in the actuated state of the actuator, is pushed away from the fluid drainage opening by a fluid flowing through the fluid supply opening and opens the fluid drainage opening;
wherein the membrane has an edge clamped between a cup-shaped element forming the valve chamber and a cover element inserted therein, and wherein, in the region of the clamping, at least one passage opening is formed between the first region and the second region, through which fluid can flow from the first region into the second region.

2. The pneumatic valve as set forth in claim 1, wherein the membrane defines at least one groove forming the passage opening and surrounding the edge thereof in the region of the cup-shaped element and the cover element.

3. The pneumatic valve as set forth in claim 1, in which the membrane includes at least one bead producing the passage opening in the clamped state and surrounding the edge thereof in the region of the cup-shaped element and the cover element.

4. The pneumatic valve as set forth in claim 1, wherein the cup-shaped element and the cover element, in their regions surrounding the edge of the membrane, define at least one groove forming the passage opening.

5. The pneumatic valve as set forth in claim 1, wherein the cup-shaped element and the cover element, in their regions surrounding the edge of the membrane, include at least one bead producing the passage opening in the membrane in the clamped state.

6. The pneumatic valve as set forth in claim 1, further comprising channels forming the passage opening defined by the cup-shaped element and the cover element.
